(19) United States
(12) Patent Application Publication
(10) Pub. No.: US 2025/0100096 A1
(43) Pub. Date: Mar. 27, 2025

(54) Apparatus For Loading And Unloading A Machine Tool For Machining Toothing Systems

(71) Applicant: Reishauer AG, Wallisellen (CH)

(72) Inventor: Michel Müller, Uster (CH)

(73) Assignee: Reishauer AG, Wallisellen (CH)

(21) Appl. No.: 18/724,983

(22) PCT Filed: Nov. 30, 2022
(86) PCT No.: PCT/EP2022/083889

§ 371 Date: Jun. 27, 2024

(30) Foreign Application Priority Data
Dec. 29, 2021 (CH) 70807/2021

(51) Int. Cl. B23Q 7/04; B23F 23/04

(52) U.S. Cl. CPC B23Q 7/043; B23F 23/04

(57) ABSTRACT

A device for loading and unloading a machine tool for machining gears, in particular a hard fine machining machine, with a workpiece includes: a base, a carrier arranged on the base and which is rotatable with respect to the base about a first axis of rotation, a gripping device arranged on the carrier for gripping and releasing the workpiece, wherein the gripping device has at least two gripper arms which are each pivotable independently of one another about a second axis of rotation, and the gripper arms are pivotable relative to one another about the second axis of rotation in such a way that the gripper arms can assume relative to one another a gripping position for gripping the workpiece and a release position for releasing the workpiece, and the gripper arms are pivotable about the second axis of rotation synchronously with one another at least in the gripping position.

### TECHNICAL FIELD

The invention relates to a device for loading and unloading a machine tool for machining gears with a workpiece. The device has a base and a carrier arranged on the base. The carrier is rotatable with respect to the base about a first axis of rotation and comprises a gripping device for gripping and releasing the workpiece.

The invention further relates to a machine tool for gear grinding a workpiece, wherein the machine tool comprises a device of the above-mentioned type. In addition, the invention relates to a method for loading and unloading a machine tool by means of a device according to the invention.

### BACKGROUND ART

So-called ring loader concepts are known from the state of the art. The devices according to the ring loader concepts have a gripping device, which is usually rotatable about an axis of rotation and comprises several pairs of gripper arms. Each pair of gripper arms is designed to grip or release a workpiece independently of the other pairs of gripper arms. In order to transport one or more workpieces, the gripping device is rotated about the axis of rotation after at least one pair of gripper arms has gripped a workpiece. As a result, all pairs of gripper arms, including the pair of gripper arms that have gripped a workpiece, are simultaneously pivoted around the axis of rotation.

Such devices known from the prior art have the disadvantage that the position of one pair of gripper arms in relation to another pair of gripper arms is fixed or cannot be changed due to the design of the gripping device. This means that rotating the gripping device around the axis of rotation causes all pairs of gripper arms to pivot simultaneously. The pairs of gripper arms cannot be used flexibly for gripping or releasing workpieces. This leads to a reduced or limited loading and unloading speed of the known devices. Furthermore, the maintainability of the known devices is also limited, especially since the gripping device is regularly spatially fixed in relation to the machine tool to be loaded and unloaded.

### SUMMARY OF THE INVENTION

The task of the invention is to provide a device for loading and unloading a machine tool, which belongs to the technical field mentioned at the beginning and which eliminates the above-mentioned problems and disadvantages of the prior art. In particular, it is a task of the present invention to provide a device for loading and unloading a machine tool which enables a fast and efficient loading and unloading with workpieces and also has increased maintainability.

To solve the problem, a device according to the invention for loading and unloading a machine tool with a workpiece comprises a base, a carrier and a gripping device. Preferably, the device is suitable for loading and unloading a hard fine machining machine with a workpiece, in particular a pre-toothed workpiece, such as a double-toothed gear blank.

Alternatively or additionally, the device may be suitable for loading and unloading the machine tool with a clamping means, a grinding wheel or similar means provided for the machine tool. Thus, for the purposes of the present invention, the term “workpiece” is not limited to a body that is machined by the machine tool. Rather, the term “workpiece” may also include means provided for the machine tool, in particular for the operation and/or maintenance of the machine tool.

The carrier of the device according to the invention is arranged on the base and is rotatable with respect to the base about a first axis of rotation. The gripping device is provided on the carrier and is designed for gripping and releasing the workpiece. Advantageously, the gripping device is arranged on the carrier such that the gripping device is pivoted about the first axis of rotation when the carrier rotates about the first axis of rotation.

According to the invention, the gripping device comprises at least two gripper arms. The gripper arms are each pivotable independently of one another about a second axis of rotation. Each gripper arm is pivotable relative to the other gripper arm about the second axis of rotation in such a way that the at least two gripper arms can assume a gripping position and a release position relative to one another. In the release position, the gripper arms are arranged relative to each other in such a way that the gripper arms can release a workpiece. This means that the gripper arms preferably cannot transport a workpiece in the release position. In the gripping position, the gripper arms are arranged relative to one another in such a way that the gripper arms can grip a workpiece, preferably together. For example, the gripper arms can transport a workpiece in the gripping position, in particular transport a workpiece together. Furthermore, the gripper arms are pivotable about the second axis of rotation synchronously with one another, at least in the gripping position. Independently of this, it may also be provided that the gripper arms are pivotable synchronously with one another about the second axis of rotation in the release position.

For the purposes of the present invention, the term “gripping” is understood to mean clamping, in particular clamping or jamming, of the workpiece between two gripper arms. Alternatively or additionally, the term “gripping” can also include gripping underneath the workpiece by the gripper arms. Preferably, the gripper arms are frictionally connected and/or connected in a form-fitting conneciton to the workpiece in the gripping position.

For the purposes of the present invention, the term “releasing” is understood to mean a release of the contact between the gripper arms and the workpiece. For example, the contact between the gripper arms and the workpiece can be released when the gripper arms change from the gripping position to the release position. A workpiece is preferably already considered to be released when the workpiece is only in contact with one gripper arm.

For the purposes of the present invention, the term “synchronous pivoting” is understood to mean simultaneous pivoting of the gripper arms, whereby the relative position of the gripper arms to one another does not change. For example, the gripper arms can be pivoted synchronously in the gripping position in such a way that a workpiece is transported between the gripper arms as a function of the pivoting movement of the gripper arms. In other words, a workpiece located between two gripper arms in the gripping position is swiveled around the second axis of rotation when the gripper arms swivel synchronously with each other around the second axis of rotation.

The pivotability of the gripper arms in relation to the second axis of rotation according to the invention means that the gripper arms can be controlled flexibly and independently of one another. This has the advantage that different gripper arms can form different pairs of gripper arms as required and, accordingly, a machine tool can be loaded and unloaded with workpieces more quickly. Furthermore, the gripper arms can be spaced so far apart in the release position that the workpiece can be processed unhindered by the machine tool. For example, the gripper arms can be pivoted relative to each other about the second axis of rotation in the release position in such a way that the distance between the gripper arms is greater than the width of an abrasive of a grinding device of the machine tool. In addition or independently of this, the arrangement of the gripping device on the rotatable carrier has the effect of increasing the accessibility of individual components. This has the advantage of increasing the maintainability of the entire device.

In a first exemplary embodiment of the device, a workpiece spindle is arranged on the carrier. The workpiece spindle is designed to rotate a workpiece arranged on the workpiece spindle. Advantageously, the gripping device is designed to load and unload the workpiece spindle with a workpiece. For example, it may be provided that the gripper arms of the gripping device change from the gripping position to the release position or from the release position to the gripping position at a loading point in order to release or grip a workpiece. The loading point is preferably located in the vicinity of the workpiece spindle, in particular above the workpiece spindle.

One embodiment, in which a workpiece spindle is arranged on the carrier, advantageously causes the workpiece spindle to be pivoted about the first axis of rotation when the carrier rotates about the first axis of rotation. This has the advantage that the workpiece spindle can be made more easily accessible for improved maintainability or can be moved into a measuring position. Furthermore, the workpiece spindle can advantageously also be loaded manually if the workpiece spindle is made accessible to a user by rotating the carrier.

The workpiece spindle can be rotatable about a third axis of rotation, in particular rotate about a third axis of rotation. Preferably, the third axis of rotation is offset parallel to the first axis of rotation. Alternatively or additionally, the third axis of rotation can be arranged parallel to the second axis of rotation.

In another exemplary embodiment, the gripping device is movable along the second axis of rotation, in particular axially movable. Preferably, the gripping device is moved along the second axis of rotation after the gripper arms have changed from the gripping position to the release position and/or from the release position to the gripping position. This advantageously causes a workpiece to be lifted or lowered by the gripping device, in particular after the gripper arms have changed from the release position to the gripping position or before the gripper arms change from the gripping position to the release position.

Preferably, the second axis of rotation is displaced parallel with respect to the first axis of rotation. This has the advantage that the device has a compact design and the accessibility of the individual components is increased. In addition, the offset of the two axes of rotation means that a large number of adjustment positions can be assumed by the device, which increases the flexibility of use of the device.

In a further advantageous embodiment, the gripping device can grip or release a workpiece independently of the position of the carrier. For example, the gripping device can be designed to grip or release a workpiece independently of the position of the carrier in relation to the first axis of rotation. Alternatively or additionally, it may be provided that the gripping device can grip or release a workpiece during a rotational movement of the carrier in relation to the first axis of rotation. Such embodiments advantageously enable the device to load and unload a machine tool in a highly flexible manner. In particular, it is conceivable that the machine tool can be loaded by the device while the carrier occupies a position for maintenance. This has the advantage that the operational readiness of the device can be ensured continuously, i.e. also at least partially during maintenance work.

The device for loading and unloading a machine tool can comprise a drive setup. Preferably, the gripping device comprises the drive setup. For example, the drive setup is arranged on the gripping device, in particular directly on the gripping device. The drive setup can be designed to drive the gripper arms independently of each other. Such a drive setup has the advantage that the gripper arms are always pivotable independently of each other about the second axis of rotation. Preferably, the drive setup is designed as a rotary drive.

In a further development of the aforementioned embodiment, the drive setup comprises a plurality of drive means. The drive means may be electric motors and/or synchronous motors, for example. Each drive means can be assigned to a respective gripper arm. For example, a first drive means can be assigned to a first gripper arm and a second drive means can be assigned to a second gripper arm. A drive setup with a plurality of drive means has the advantage that the gripper arms can always be pivotable independently of each other about the second axis of rotation. In particular, if one drive means fails, it can be ensured that the other drive means continue to drive the other gripper arms. For example, the drive means can be designed in such a way that the drive means switch to idle mode in the event of failure, so that the assigned gripper arm is freely pivotable about the second axis of rotation.

Each gripper arm can be arranged on a drive ring. Each drive ring is mounted so that it can rotate about the second axis of rotation. For example, the drive rings can be supported in a base body of the gripping device so that they can rotate relative to each other via roller bearings and/or plain bearings. Advantageously, the respective gripper arm of a drive ring is pivoted about the second axis of rotation when the corresponding drive ring rotates about the second axis of rotation. The direct assignment of a gripper arm to a drive ring has the advantage that the gripper arms can be driven individually and independently of each other. The drive ring can be annular, in particular circular, semi-annular or partially annular. The drive ring can be connected to the respective gripper arms in a force-fit, form-fit and/or material-fit manner. Alternatively, it is also conceivable that the drive ring and the respective gripper arm are formed in one piece, in particular are integrally formed with each other. Preferably, the respective gripper arm is arranged on a radial outer lateral surface of the respective drive ring in relation to the second axis of rotation.

In a further embodiment in which the device has drive means and drive rings, each drive ring can have an internal toothing and each drive means can have a spur gear with an external toothing. Advantageously, the drive means and the drive rings are arranged in relation to each other such that the external toothing of a drive means engages with the internal toothing of a drive ring. Advantageously, the engagement causes a rotational movement generated by the drive means to be transmitted to the corresponding drive ring in such a way that the drive ring rotates about the second axis of rotation. In particular, this drives the gripper arms arranged on the corresponding drive ring. Such a further development has the advantage that the rotational movement generated by the drive means can be transmitted to the drive ring, and thus also to the corresponding gripper arm, with virtually no loss.

Alternatively or additionally, the drive means can also drive the drive rings via other drive connections. For example, an external toothing can be provided on one or more drive rings, in which the respective drive means engages. Independently of this, chain drives and/or belt drives are also conceivable as drive connections between the drive rings and the drive means. Linear motors can also be used.

Alternatively, a curved guide can be used to guide the gripper arms.

It is also conceivable that a gearbox is provided between the drive setup and the gripper arms. For example, a gearbox can be provided between each drive means and the corresponding drive ring. Alternatively, the gearbox can also be arranged only between individual drive means and drive rings. The gearbox can be designed for overdrive and/or reduction of the rotational movement of the drive setup, in particular of the respective drive means. The use of a gearbox can be particularly advantageous if the pivot movement of the gripper arms about the second axis of rotation must be very fine and/or if an increased gripping force is required.

In another exemplary embodiment, one gripping means can be arranged on one, several or each of the gripper arms. Irrespective of this, several gripping means can be arranged on one gripper arm. Advantageously, the gripping means is arranged on the corresponding gripper arm in such a way that the gripping means faces a cooperating gripper arm, in particular a gripping means of a cooperating gripper arm. Preferably, the gripping means is designed to contact the workpiece when the gripper arms are in the gripping position. For example, a gripping means can be designed to exert a clamping force on the workpiece in the gripping position. Alternatively or additionally, the gripping means can comprise a protrusion with which a workpiece can be gripped underneath. This means that a workpiece is gripped underneath by the protrusion of one or more gripping means in particular when the corresponding gripper arms change from the release position to the gripping position or are in the gripping position.

A gripping means advantageously improves the frictional and/or positive locking between the gripper arms and the workpiece in the gripping position. This has the advantage that the workpiece can be transported more safely by the gripping device, in particular it can be pivoted more safely around the second axis of rotation.

The gripping device can be designed to grip several workpieces at the same time. Advantageously, this means that the machine tool can be loaded and unloaded more quickly and effectively by the device for loading and unloading the machine tool.

In an exemplary embodiment, the gripping device can comprise a first gripper arm, a second gripper arm and a third gripper arm. Preferably, the second gripper arm is provided between the first gripper arm and the third gripper arm in the circumferential direction of the second axis of rotation. In other words, the sequence of the gripper arms in the circumferential direction of the second axis of rotation can be constant regardless of the respective positions (gripping and/or release position). Advantageously, this means that the gripping device is very easy to control. This has the advantage that the device for loading and unloading a machine tool can be manufactured and operated in a cost-effective and less time-consuming manner.

In a further development of the aforementioned embodiment, the gripping device can be designed in such a way that the second gripper arm can assume a gripping position or a release position relative to the first gripper arm. Independently thereof, it may be provided that the second gripper arm can assume a gripping position or a release position relative to the third gripper arm. In other words, the second gripper arm can be designed in such a way that the second gripper arm can assume a gripping position and/or a release position on both sides. The second gripper arm can contact a workpiece on each side in the circumferential direction of the second axis of rotation. Such a further development advantageously means that a workpiece can be gripped between the first gripper arm and the second gripper arm regardless of the position of the second gripper arm in relation to the third gripper arm. This also applies analogously in reverse. This means that a workpiece can be gripped between the second gripper arm and the third gripper arm regardless of the position of the second gripper arm in relation to the first gripper arm. The advantage of a further development in which the second gripper arm is arranged in the circumferential direction between the first gripper arm and the third gripper arm is that the gripping device can, for example, grip and/or release no workpiece, a workpiece between the first gripper arm and the second gripper arm, a workpiece between the second gripper arm and the third gripper arm, or two workpieces simultaneously. This ensures fast, efficient and flexible loading and unloading.

In a further exemplary embodiment of the device, the carrier is rotatable about the first axis of rotation in such a way that the carrier is adjustable between an operating position and a maintenance position. In particular, the carrier can rotate about the first axis of rotation in such a way that the carrier can switch back and forth between the operating position and the maintenance position. Preferably, in the operating position, the machine tool is loaded and unloaded with the workpieces by the device. In the maintenance position, the machine tool and/or the device can be maintained. Alternatively or additionally, the machine tool and/or the device can be manually loaded with one or more workpieces in the maintenance position. This has the advantage that the device is easily accessible for a user.

The carrier can be mounted hydrostatically on the base. The carrier can be mounted hydrostatically on the base, in particular to improve the rotatability of the carrier about the first axis of rotation. This has the advantage that the carrier remains rotatable, in particular smoothly rotatable, in relation to the first axis of rotation even with heavy loads, in particular with heavy workpieces that have a dead weight of >100 kg, for example. In addition, a hydrostatic bearing enables high rigidity of the connection between carrier and base and precise positioning.

Independently of this, the carrier can have a carrier tower. The carrier tower is preferably arranged vertically on the carrier. Independently of this, the carrier tower can be provided eccentrically on the carrier in relation to the first axis of rotation. An outer lateral surface of the carrier tower can delimit the carrier tower radially outwards in relation to the second axis of rotation. For example, the gripping device is arranged on the outer lateral surface of the carrier tower. This advantageously means that the gripping device is easily accessible for maintenance work.

A dressing device can be provided on the carrier. The dressing device can be designed for dressing an abrasive of a grinding device of the machine tool. Preferably, the dressing device is arranged radially offset on the carrier in relation to the first axis of rotation. This has the effect that when the carrier rotates about the first axis of rotation, for example, the dressing device is pivoted about the first axis of rotation. This has the advantage that the dressing device can be positioned relative to the abrasive by rotating the carrier about the first axis of rotation in such a way that the abrasive can be dressed by the dressing device. For this purpose, the carrier can, for example, assume a dressing position. Independently of this, the dressing device can also be made more easily accessible for a user by rotating the carrier about the first axis of rotation, in particular making it more easily accessible for maintenance work.

In an exemplary further development of the aforementioned embodiment, the dressing device can be movable in relation to the carrier. Preferably, the dressing device is translationally movable with respect to the carrier. In particular, the dressing device can be movable with respect to the carrier in such a way that a translational movement of the dressing device causes a change in the distance between the dressing device and the first axis of rotation. In other words, the translational movement of the dressing device can be orthogonal to the first axis of rotation. For example, the dressing device can be moved 100 mm to 200 mm, preferably 125 mm to 175 mm and particularly preferably 150 mm, with respect to the carrier, in particular away from the carrier. Advantageously, this has the effect that a collision with the gripping device can be effectively prevented. In addition, or independently thereof, the spacing apart of the dressing device from the carrier can greatly reduce soiling of the gripping device, for example due to abrasion caused by dressing the abrasive.

Alternatively or additionally, the dressing device can be rotationally movable in relation to the carrier. For example, the dressing device can be pivotable about a pivot axis of the dressing device in relation to the carrier. The pivot axis of the dressing device can be arranged parallel to the first axis of rotation. If the dressing device can be moved translationally and rotationally in relation to the carrier, a translational movement of the dressing device can cause the distance between the pivot axis of the dressing device and the first axis of rotation to change.

The embodiment with a dressing device that can be moved in relation to the carrier advantageously means that the dressing device can be positioned particularly well in relation to the abrasive. This has the advantage that the abrasive can be dressed particularly precisely by the dressing device.

In another exemplary embodiment, the device comprises a profiling device. The profiling device can be designed for profiling, in particular for pre-profiling, the abrasive of the grinding device. For example, the profiling device can have a rotary cutting edge, past which cutting edge the abrasive can be rotated in order to introduce a profile into the abrasive. Preferably, the profiling device is arranged on the gripping device, in particular on a drive ring or on the base body of the gripping device. Such an arrangement of the profiling device advantageously means that the profiling device can be axially movable in relation to the second axis of rotation and/or can be pivoted about the second axis of rotation. This has the advantage that the profiling device can be positioned particularly well in relation to the abrasive.

In another exemplary embodiment, the device comprises a centering device. The centering device can be designed to align, in particular to center, the workpiece in relation to another component of the device and/or in relation to a component of the machine tool. For example, the centering device can be provided for aligning, in particular centering, a workpiece in relation to the workpiece spindle. The centering device can additionally or alternatively be designed to support the workpiece. For example, the centering device can support the workpiece when the workpiece is driven by the workpiece spindle. The centering device is preferably a tailstock. The embodiment with centering device has the advantage that the machine tool can be loaded very precisely by the device and/or the workpiece can be held in position during machining. This increases the accuracy of the machine tool in particular. Advantageously, manufacturing tolerances on the workpiece can be minimized.

The device may have a position-determining device. The position-determining device is preferably designed to detect the position of the workpiece, in particular of at least one tooth space of the workpiece. For example, the position-determining device detects the position of the workpiece after the machine tool has been loaded with the workpiece. Alternatively or additionally, the position-determining device detects the position of the workpiece after the workpiece has been arranged on the workpiece spindle by the gripping device. In particular, the position determining device can be designed to determine the position of tooth flanks or tooth spaces of the workpiece. Alternatively or additionally, the position determining device can be designed to determine the position of the gripper arms, in particular to determine the position of the gripper arms in relation to the second axis of rotation.

To determine the respective position, the position-determining device can comprise at least one sensor. The sensor can be an optical and/or an electromagnetic sensor, in particular a distance sensor. The sensor can be a Hall sensor, for example. Detecting the position of the workpiece by the position-determining device has the advantage of increasing the accuracy of the machine tool. For example, an abrasive of a grinding device of the machine tool can be better aligned with the workpiece depending on the determined position of the workpiece, whereby the allowance of the workpiece is regularly distributed over the circumference and the manufacturing tolerances on the workpiece can be minimized. In particular, the position-determining device can be used to determine the position of the workpiece in such a way that it is ensured that the abrasive does not collide with a tooth head of the workpiece when it is brought into contact.

According to the invention, the task mentioned at the beginning is also solved by a machine tool for gear grinding of a workpiece, in particular for hard fine machining of a pre-toothed workpiece, such as a gear blank. For this purpose, the machine tool comprises a machine housing, a grinding device and a device as described above. According to the invention, the grinding device is arranged on the machine housing and is designed for grinding the workpiece. The machine housing of the machine tool forms the base of the device according to the above embodiments.

The machine tool according to the invention has the advantage that the machine tool can be loaded and unloaded with workpieces more quickly by means of the device. In addition or independently thereof, the carrier, which can be rotated about the first axis of rotation, has the effect of increasing the accessibility to the individual components of the machine tool. This has the advantage that the machine tool according to the invention is easier to maintain.

In a first exemplary embodiment, the machine tool comprises a dressing device arranged on the carrier and a workpiece spindle arranged on the carrier. The dressing device can be designed for dressing, in particular for profiling and/or resharpening, the abrasive of the grinding device. Preferably, the dressing device is arranged radially offset on the carrier in relation to the first axis of rotation. This has the effect that when the carrier rotates about the first axis of rotation, for example, the dressing device is pivoted about the first axis of rotation. The dressing device can be arranged on the carrier so that it can move, in particular move translationally and/or rotationally. Preferably, the dressing device is arranged on the carrier on a side of the carrier facing away from the workpiece spindle. For example, the dressing device is arranged on the carrier at a position offset by 180° to the workpiece spindle in relation to the first axis of rotation.

The workpiece spindle is preferably designed to rotate a workpiece arranged on the workpiece spindle. Advantageously, the gripping device is designed to load and unload the workpiece spindle with a workpiece. The workpiece spindle can be rotatable about a third axis of rotation, in particular rotate about a third axis of rotation. Preferably, the third axis of rotation is offset parallel to the first axis of rotation. This has the effect that when the carrier rotates about the first axis of rotation, for example, the workpiece spindle is pivoted about the first axis of rotation.

The carrier can be rotated about the first axis of rotation in such a way that the carrier can be rotated back and forth between a grinding position and a maintenance position. Preferably, the workpiece spindle faces the grinding device in the grinding position. This advantageously means that a workpiece can be machined on the workpiece spindle by the grinding device in the grinding position. In the maintenance position, the dressing device can face the grinding device. Advantageously, this means that an abrasive of the grinding device can be maintained by the dressing device in the maintenance position.

The machine tool according to the first embodiment has the advantage that the machine tool is easy to handle and easy to maintain for a user.

Additionally or alternatively, the workpiece spindle and/or the gripping device may be more easily, in particular freely, accessible to a user in an access position. The access position of the carrier may correspond to the maintenance position of the carrier.

In an exemplary embodiment, the machine tool has a profiling device in addition to the dressing device. The profiling device can be designed for profiling, in particular for pre-profiling, the abrasive of the grinding device. For example, the profiling device can have a rotary cutting edge, to which cutting edge the abrasive can be rotated past in order to create a profile in the abrasive. The profiling device is preferably arranged on the gripping device. Advantageously, the profiling device faces the grinding device when the carrier is in the maintenance position. In particular, this means that the abrasive can be pre-profiled very quickly one after the other and then dressed. Pre-profiling is preferably carried out by the profiling device and dressing by the dressing device. This has the advantage that maintenance work on the abrasive can be reduced to a minimum in terms of time.

According to the invention, the task mentioned at the beginning is also solved by a Method with a device according to the above embodiments. Preferably, the device has a first gripper arm, a second gripper arm and a third gripper arm. The method for loading and unloading a machine tool by means of such a device has the advantage that the machine tool can be loaded and unloaded with workpieces more quickly, in particular the change of several workpieces can be carried out more quickly.

The Method for loading and unloading the machine tool with a workpiece can comprise an initial loading process, i.e. an initial loading of the machine tool with a workpiece. As part of the initial loading process, the first gripper arm and the second gripper arm are preferably pivoted relative to one another about the second axis of rotation in such a way that the first gripper arm and the second gripper arm assume a gripping position relative to one another in order to grip a first workpiece. The first gripper arm and the second gripper arm can grip the first workpiece at a pick-up position, for example. After the first workpiece has been gripped by the first gripper arm and the second gripper arm, it is conceivable that the gripping device is moved axially along the second axis of rotation. This can be useful, for example, if the first workpiece is to be lifted after gripping. During a further process step of the initial loading process, the first gripper arm and the second gripper arm are pivoted around the second axis of rotation in synchronization with each other. During the synchronous pivoting process, the first gripper arm and the second gripper arm remain in the gripping position relative to each other. This means that the first workpiece is also pivoted around the second axis of rotation. This allows the first workpiece to be transported from the pick-up position to a loading position. Preferably, the loading position is located on or at a workpiece spindle.

Optionally, the gripping device can be moved axially along the second axis of rotation after synchronous pivoting of the first gripper arm and the second gripper arm. This has the advantage that the first workpiece can, for example, be lowered onto the workpiece spindle or placed on the workpiece spindle. In a final process step of the initial loading process, the first gripper arm and the second gripper arm are pivoted relative to each other about the second axis of rotation in such a way that the first gripper arm and the second gripper arm assume a release position relative to each other. As a result, the workpiece is released from the first gripper arm and the second gripper arm at the loading position. Preferably, the first gripper arm and the second gripper arm are spaced apart in the last process step of the initial loading process to such an extent that the first workpiece can be machined at the loading position by a grinding device, in particular can be machined unhindered.

In an exemplary embodiment, the Method comprises a workpiece change process. Preferably, the workpiece change process replaces a first workpiece with a second workpiece. For example, the first workpiece may have been ground by the machine tool and, in particular, be located on the workpiece spindle. In order to be able to subsequently grind a second workpiece, for example, the first workpiece on the workpiece spindle must be replaced by the second workpiece or exchanged with the second workpiece.

At the start of the workpiece change process, the second workpiece can be gripped by the second gripper arm and the third gripper arm. For this purpose, the second gripper arm and the third gripper arm can be pivoted relative to one another about the second axis of rotation in such a way that the second gripper arm and the third gripper arm assume a gripping position relative to one another. During a further step of the workpiece change process, the first gripper arm and the second gripper arm can be pivoted relative to one another about the second axis of rotation in such a way that the first gripper arm and the second gripper arm change relative to one another from the release position to the gripping position. For example, the first gripper arm and the second gripper arm can grip the first workpiece by changing from the release position to the gripping position.

The third gripper arm is preferably pivoted about the second axis of rotation in such a way that the third gripper arm follows the second gripper arm synchronously. This advantageously causes the second gripper arm and the third gripper arm to remain in the gripping position relative to each other and the second workpiece follows the movement of the second gripper arm and the third gripper arm.

This Method means that a second workpiece can be provided directly next to the first workpiece. Advantageously, this means that the gripper arms only need to be pivoted slightly, for example within a pivot range of <90°, preferably within a pivot range of <45°, for the actual exchange of the two workpieces. Such a small pivot range has the advantage of ensuring that the workpieces can be changed quickly and effectively during the workpiece change process.

If the first workpiece has been gripped by the first gripper arm and the second gripper arm, and the second workpiece has been gripped by the second gripper arm and the third gripper arm, a transport operation, as described in more detail below, can take place as part of the workpiece change process. During the transport operation, the first gripper arm, the second gripper arm and the third gripper arm are preferably pivoted synchronously with one another about the second axis of rotation in such a way that the first workpiece and the second workpiece are also pivoted synchronously with one another about the second axis of rotation. Preferably, the second gripper arm is used on both sides during the transport operation. This means that the second gripper arm is in contact with the first workpiece on its side facing the first gripper arm and is in contact with the second workpiece on its side facing the third gripper arm. The advantage of this is that as many workpieces as possible can be transported at once with the smallest possible number of gripper arms. This has the advantage that the workpieces are transported particularly efficiently.

In a further step of the workpiece change process, the second workpiece can then be released at the loading position. For this purpose, the second gripper arm and the third gripper arm are pivoted relative to one another about the second axis of rotation in such a way that the second gripper arm and the third gripper arm assume a release position relative to one another. The first workpiece can be transported to a deposit position by synchronously pivoting the first gripper arm and the second gripper arm around the second axis of rotation. Subsequently, the first gripper arm and the second gripper arm can be pivoted relative to one another about the second axis of rotation in such a way that the first gripper arm and the second gripper arm assume a release position relative to one another and release the first workpiece at the deposit position.

Preferably, the method of loading and unloading the machine tool comprises a plurality of workpiece change processes. In particular, the method may comprise a first workpiece change process and a second workpiece change process. For example, during the first workpiece change process, a first workpiece may be replaced by a second workpiece. This process has been described above.

During the first workpiece change process, the second gripper arm is preferably pivoted in a first pivoting direction about the second axis of rotation. In particular during the transport operation as part of the first workpiece change process, the second gripper arm is pivoted in a first pivoting direction about the second axis of rotation.

Analogous to the first workpiece change process, the second workpiece can be replaced by a third workpiece during the second workpiece change process. During the second workpiece change process, the second gripper arm can be pivoted in a second pivoting direction about the second axis of rotation. The second pivoting direction is preferably opposite to the first pivoting direction. In other words, the first pivoting direction and the second pivoting direction are preferably opposite directions. For example, the second gripper arm is pivoted in the second pivoting direction about the second axis of rotation during a transport operation as part of the second workpiece change process. Advantageously, this has the effect that the machine tool, in particular a workpiece spindle of the machine tool, can be loaded and unloaded from different directions, for example from the left and from the right. Such a method has the advantage that a faster and more effective change of workpieces is ensured.

In an exemplary further development of the two aforementioned embodiments of the method for loading and unloading a machine tool, the second gripper arm and the third gripper arm can be pivoted relative to one another about the second axis of rotation during the second workpiece change process in such a way that the second gripper arm and the third gripper arm change relative to one another from the release position to the gripping position. For example, the second gripper arm and the third gripper arm can grip the second workpiece by changing from the release position to the gripping position. Alternatively, the second gripper arm and the third gripper arm can be pivoted relative to one another about the second axis of rotation during the workpiece change process in such a way that the second gripper arm and the third gripper arm change relative to one another from the gripping position to the release position, for example for releasing a workpiece between the second gripper arm and the third gripper arm.

Regardless of whether the second gripper arm and the third gripper arm change from the release position to the gripping position, or whether the second gripper arm and the third gripper arm change from the gripping position to the release position, the first gripper arm is preferably pivoted about the second axis of rotation during the second workpiece change process in such a way that the first gripper arm follows the second gripper arm synchronously. Advantageously, this means that if, for example, the first gripper arm and the second gripper arm assume a gripping position relative to each other and a third workpiece is arranged between the first gripper arm and the second gripper arm, the third workpiece follows the movement of the second gripper arm. The advantage of such a method is that the second workpiece change process ensures that the workpieces can be changed quickly and effectively.

In another exemplary embodiment, the Method comprises a transport operation. The transport operation, which has already been indicated in the above explanations, can be provided for two workpieces to be transported simultaneously. This can be particularly advantageous in the context of a workpiece change process. During the transport operation, for example, a first workpiece can be transported away, in particular transported away from the loading position, and a second workpiece can be transported at the same time, in particular transported to the loading position. For example, during the transport operation, a first workpiece can be transported away from the workpiece spindle and a second workpiece can be transported towards the workpiece spindle. Preferably, a first workpiece is arranged between the first gripper arm and the second gripper arm during the transport operation, with the first gripper arm and the second gripper arm assuming a gripping position relative to each other. In addition, a second workpiece can be arranged between the second gripper arm and the third gripper arm, with the second gripper arm and the third gripper arm assuming a gripping position relative to each other. In other words, the second gripper arm is preferably arranged between the first workpiece and the second workpiece during the transport operation. To transport the workpieces, the first gripper arm, the second gripper arm and the third gripper arm can be pivoted synchronously with one another about the second axis of rotation. As a result, the workpieces are transported simultaneously, in particular pivoted around the second axis of rotation at the same time.

### BRIEF DESCRIPTION OF THE DRAWINGS

The different and exemplary features described above can be combined with each other according to the invention, insofar as this is technically sensible and suitable. Further features, advantages and embodiments of the invention are shown in the following description of examples of embodiments and with reference to the figures. The figures show:

FIG. 1 a perspective view of an embodiment of a grinding machine with a device for loading and unloading the grinding machine;

FIG. 2 a perspective view of a gripping device according to the embodiment of the device for loading and unloading the grinding machine shown in FIG. 1;

FIG. 3 detail from a sectional view of the gripping device as shown in FIG. 2;

FIG. 4 detail from another sectional view of the gripping device as shown in FIG. 2;

FIG. 5 a second embodiment of a gripping device;

FIG. 6 a top view of the embodiment according to FIG. 1 during an initial loading process;

FIG. 7 a top view of the embodiment according to FIG. 1 at the beginning of a workpiece change process;

FIG. 8 a top view of the embodiment according to FIG. 1 at the beginning of a transport operation as part of the workpiece change process;

FIG. 9 a top view of the embodiment according to FIG. 1 in a maintenance position or a position for depositing the workpiece on the operator side;

FIG. 10 a sectional view of a part of the embodiment according to FIG. 1; and

FIG. 11 a perspective view of a part of another embodiment of a grinding machine with a device for loading and unloading the grinding machine.

### WAYS TO IMPLEMENT THE INVENTION

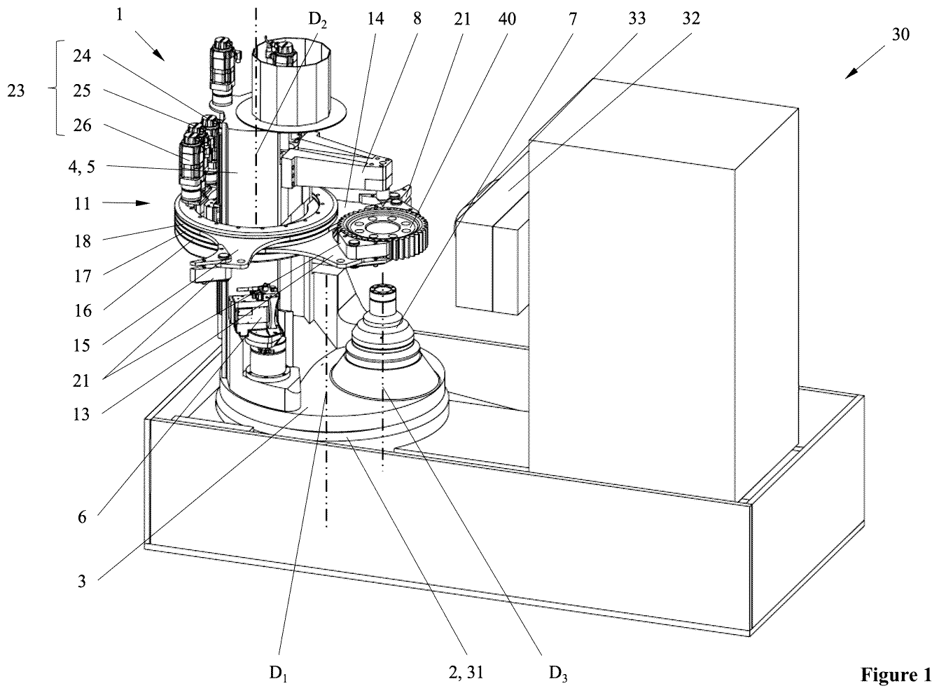

FIG. 1 shows a perspective view of an embodiment of a grinding machine 30 with a device 1 for loading and unloading the grinding machine 30, in particular for loading and unloading the grinding machine 30 with a workpiece 40. In the embodiment shown, the grinding machine 30 is a gear grinding machine 30. The gear grinding machine 30 is designed to machine the workpiece 40, in particular to grind it. The workpiece 40 can be a pre-toothed workpiece 40, in particular a gear blank 40.

The grinding machine 30 shown here only schematically comprises a grinding device 32 with an abrasive 33 for grinding the workpiece 40. The abrasive 33 is, for example, a grinding worm 33. The grinding device 32 is arranged on a machine housing 31. The machine housing 31 also forms a base 2 for the device 1 for loading and unloading the grinding machine 30.

The device 1 for loading and unloading the grinding machine 30 has a carrier 3 and a gripping device 11.

The carrier 3 is connected to the base 2 and is rotatable with respect to the base 2 about a first vertical axis of rotation D₁. A carrier tower 4 of the carrier 3 is radially offset with respect to the first axis of rotation D₁ and has an outer lateral surface 5. A second vertical axis of rotation D₂ extends in the carrier tower 4 in the illustrated embodiment example and is offset parallel to the first axis of rotation D₁.

A dressing device 6 is arranged on the carrier 3. The dressing device 6 is designed to dress the abrasive 33 of the grinding device 32, in particular to profile and/or resharpen it. Furthermore, a workpiece spindle 7 is arranged on the carrier 3. The workpiece spindle 7 is rotatable with respect to the carrier about a third axis of rotation D₃. The workpiece spindle 7 is designed to rotate about the third axis of rotation D₃, in particular to rotate when a workpiece 40 is arranged on the workpiece spindle 7.

The gripping device 11 is arranged on the carrier 3, in particular on the carrier tower 4, and is movable along the outer lateral surface 5 of the carrier tower 4. In other words, the gripping device 11 is axially movable along the second axis of rotation D₂. The gripping device 11 is designed to grip and release the workpiece 40.

The gripping device 11 has a first gripper arm 13, a second gripper arm 14 and a third gripper arm 15. Each of the gripper arms 13, 14, 15 is pivotable about the second axis of rotation D₂ independently of the other gripper arms 13, 14, 15. The sequence of the gripper arms 13, 14, 15 is determined in the circumferential direction of the second axis of rotation D₂ in such a way that the second gripper arm 14 is always arranged between the first gripper arm 13 and the third gripper arm 15.

A gripping means 21 is arranged on each of the first and third gripper arms 13, 15. In the illustrated embodiment example, two gripping means 21 are arranged on the middle, second gripper arm 14. The gripping means 21 are arranged on the gripper arms 13, 14, 15 in such a way that in each case the gripping means 21 of an outer gripper arm 13, 15 can interact with the gripping means 21 of the middle gripper arm 14 facing it. The gripping means 21 each comprise an upper part and a lower part, with the corresponding gripper arm 13, 14, 15 being arranged between the upper part and the lower part. Preferably, the upper part and the lower part of the respective gripping means 21 are connected to each other via a pin extending through the corresponding gripper arm 13, 14, 15. The gripping means 21 are immovably connected to the respective gripper arm 13, 14, 15. Preferably, the connection between the gripping means 21 and the respective gripper arms 13, 14, 15 is detachable to allow replacement of the gripping means 21. Both the upper part and the lower part of a gripping means 21 form a gripping jaw with a circular ring section-shaped inner contour, the diameter of which is adapted to the diameter of the workpiece 40 to be gripped.

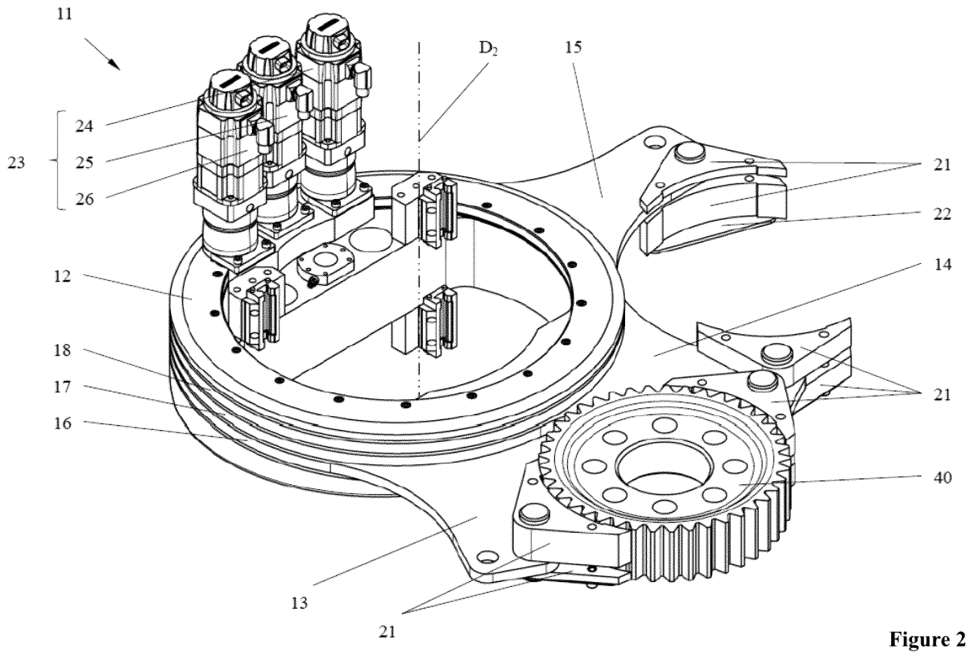

Each gripper arm 13, 14, 15 is arranged on a drive ring 16, 17, 18 (see also FIG. 2). In the embodiment example shown, the first gripper arm 13 is arranged on a first drive ring 16, the second gripper arm 14 on a second drive ring 17 and the third gripper arm 15 on a third drive ring 18. The drive rings 16, 17, 18 can each be rotated independently of one another about the second axis of rotation D₂. The connection between the drive rings 16, 17, 18 and the corresponding gripper arms 13, 14, 15 is designed in such a way that the corresponding gripper arm 13, 14, 15 is pivoted about the second axis of rotation D₂ when the respective drive ring 16, 17, 18 rotates about the second axis of rotation D₂.

The gripping device 11 comprises a drive setup 23, which is designed to drive the gripper arms 13, 14, 15 independently of one another. The drive setup 23 comprises a plurality of drive means 24, 25, 26, in particular a first drive means 24, a second drive means 25 and a third drive means 26, each of which drives a drive ring 16, 17, 18.

FIG. 2 shows a perspective view of the gripping device 11 according to the embodiment in FIG. 1.

As can be seen in FIG. 2, the workpiece 40 is gripped by the first gripper arm 13 and the second gripper arm 14. For this purpose, the first gripper arm 13 and the second gripper arm 14 are pivoted about the second axis of rotation D₂ in such a way that the first gripper arm 13 and the second gripper arm 14 assume a gripping position relative to one another.

The workpiece 40 is contacted by a gripping means 21 arranged on the first gripper arm 13 and a gripping means 21 arranged on the second gripper arm 14. The gripping means 21 jointly exert a clamping force on the workpiece 40. In addition, the gripping means 21 each have a protrusion 22, as can be seen on the gripping means 21 of the third gripper arm 15. With the protrusion 22, the workpiece can be gripped underneath by the gripping means 21.

In the position shown in FIG. 2, the second gripper arm 14 and the third gripper arm 15 assume a release position relative to one another. In the release position, the second gripper arm 14 and the third gripper arm 15 are so far apart, in particular so far apart in the circumferential direction of the second axis of rotation D₂, that no workpiece can be gripped by the second gripper arm 14 and the third gripper arm 15. The distance between the second gripper arm 14 and the third gripper arm 15 is such that no clamping force can be applied to a workpiece via the gripping means 21. In addition, the distance between the second gripper arm 14 and the third gripper arm 15 is selected so that a workpiece cannot be gripped underneath by the protrusions 22.

The drive rings 16, 17, 18 are arranged axially next to each other, in particular one above the other, in relation to the second axis of rotation D₂. A base body 12 of the gripping device 11 axially limits the drive rings 16, 17, 18.

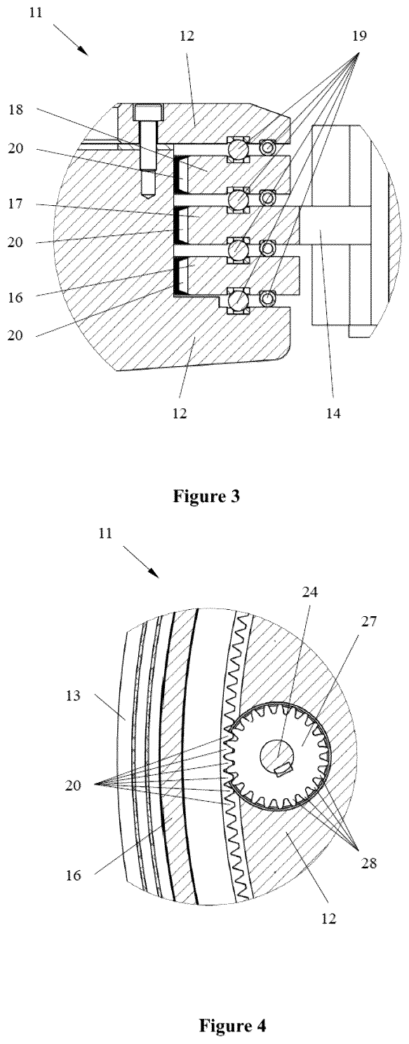

FIG. 3 shows the arrangement of the drive rings 16, 17, 18 as a detail of a vertical sectional view of the gripping device 11. The sectional view in FIG. 3 was selected so that the section runs parallel to the second axis of rotation D₂.

The drive rings 16, 17, 18 are mounted rotatably against each other via roller bearings 19. The two outer drive rings, in particular the first drive ring 16 and the third drive ring 18, are each supported axially on the outside via a roller bearing 19 on the base body 12 of the gripping device 11. The bearing shown in FIG. 3 acts like an angular contact ball bearing, so that axial and radial forces can be transmitted via the roller bearings 19.

The drive rings 16, 17, 18 are circular in the embodiment described here. In alternative embodiments, the drive rings 16, 17, 18 can be semi-circular or partly-circular.

As shown in FIG. 3 by example of the second gripper arm 14 and the second drive ring 17, the gripper arms 13, 14, 15 are arranged on the drive rings 16 radially outwards on the drive rings 16, 17, 18.

Each drive ring 16, 17, 18 has an internal toothing 20 on its inner lateral surface.

FIG. 4 shows, for example, the internal toothing 20 of the first drive ring 16 as a detail of a horizontal sectional view of the gripping device 11. For a better understanding, a section through the gripping device 11 orthogonal to the second axis of rotation D₂ was selected for the sectional view in FIG. 4.

As already described above, each gripper arm 13, 14, 15 is driven by the corresponding drive ring 16, 17, 18. The drive rings 16, 17, 18 are in turn each driven by a drive means 24, 25, 26 of the drive setup 23. The sectional view shown in FIG. 4 shows a drive axis of the first drive means 24, which is non-rotatably connected to a spur gear 27. The spur gear 27 is rotatably mounted within the base body 12 of the gripping device 11. The spur gear 27 has an external toothing 28, which engages with the internal toothing 20 of the first drive ring 16. As a result of this engagement, when the spur gear 27 is driven by the drive means 24, the rotational movement of the spur gear 27 causes the drive ring 16 to rotate about the second axis of rotation D₂. Accordingly, the first gripper arm 13 arranged on the first drive ring 16 is also pivoted about the second axis of rotation D₂.

The drive of the drive ring 16 explained by way of example in FIG. 4 can be applied analogously to all other drive rings 17, 18. Accordingly, the second drive ring 17 is driven by the second drive means 25 and the third drive ring 18 is driven by the third drive means 26.

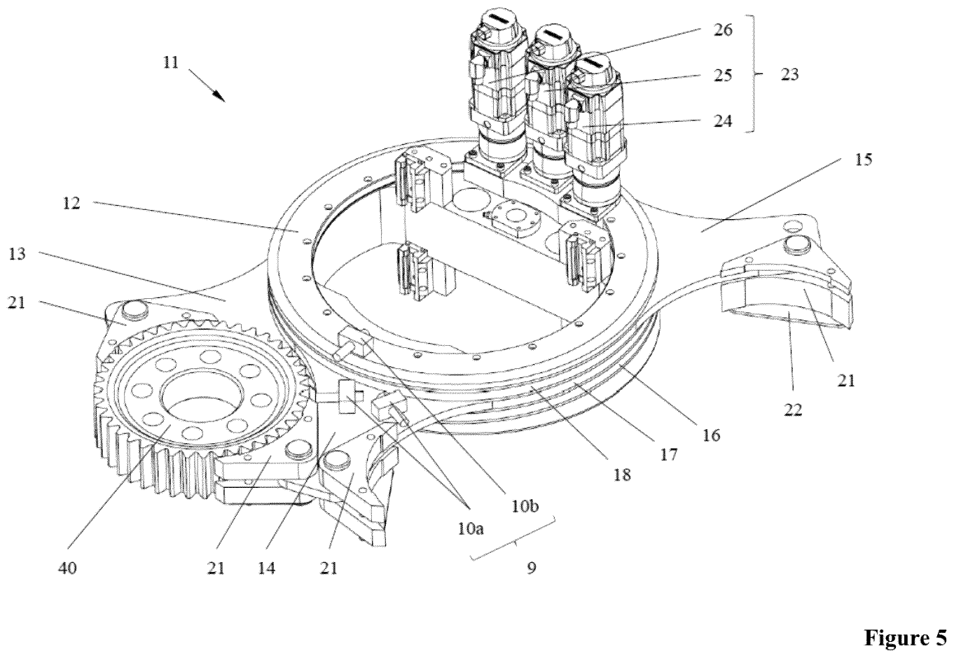

FIG. 5 shows a second embodiment of the gripping device 11. The structure of the gripping device 11 according to the second embodiment corresponds in principle to the structure of the gripping device 11 according to the first embodiment.

The only difference between the two embodiments of the gripping device 11 is that the gripping device 11 in the second embodiment comprises a position-determining device 9.

The position-determining device 9 comprises two sensors 10a, each of which is arranged on the second gripper arm 14. The sensors 10a are positioned on the second gripper arm 14 in such a way that the sensors 10a each face a workpiece 40 when the second gripper arm 14 is in a gripping position with the first gripper arm 13 and/or with the third gripper arm 15 and a workpiece 40 is arranged between the respective gripper arms.

In the position shown in FIG. 5, the second gripper arm 14 is in a gripping position with the first gripper arm 13, with a workpiece 40 arranged between the second gripper arm 14 and the first gripper arm 13. The second gripper arm 14 and the third gripper arm 15 are in a release position relative to one another, so that no workpiece 40 is arranged between the second gripper arm 14 and the third gripper arm 15.

The sensors 10a can be optical and/or electromagnetic sensors 10a, in particular Hall sensors. Preferably, the sensors 10a are designed to determine the position of the corresponding workpiece 40, in particular the rotational angle position of the corresponding workpiece 40. The position-determining can be carried out using the tooth flanks of the workpiece 40.

For example, starting from the gripping position shown in FIG. 5, the first gripper arm 14 and the second gripper arm 15 can be moved into a release position in such a way that the workpiece 40 can be rotated by the workpiece spindle 7, but with the sensors 10a still facing the workpiece 40. This allows the sensors 10a to detect the teeth of the workpiece 40 rotating past the sensors 10a.

The position-determining device 9 further comprises a sensor 10b which is designed to determine the position of the respective gripper arms 13, 14, 15 and/or the position of the workpiece 40 located between the respective gripper arms 13, 14, 15. Alternatively or additionally, the sensor 10b may also be designed to determine the position of the workpiece 40 arranged in front of the sensor 10b, in particular the rotational angle position of the workpiece 40 arranged in front of the sensor 10b. The sensor 10b can be an optical and/or electromagnetic sensor 10b.

Alternatively, the position-determining of the gripper arms 13, 14, 15 can be carried out via the drive means 24, 25, 26. This is particularly advantageous if the drive means 24, 25, 26 are synchronous motors 24, 25, 26. For example, the positions of the gripper arms 13, 14, 15 could be determined based on the number of rotational steps performed by the synchronous motors 24, 25, 26 in each case.

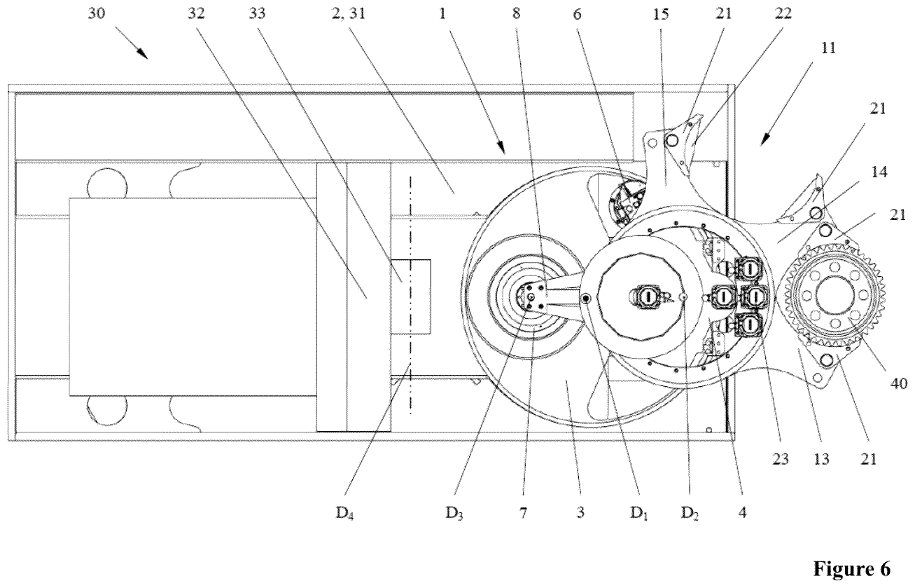

FIG. 6 shows a top view of the grinding machine 30 according to FIG. 1. With regard to the specific structure of the grinding machine 30, the device 1 for loading and unloading the grinding machine 30, and in particular the gripping device 11, reference is made to the above explanations. In contrast to FIG. 1, a fourth axis of rotation D₄ can be seen in FIG. 6.

The abrasive 33 of the grinding device 32 is designed to be rotated about the fourth axis of rotation D₄.

In the embodiment shown in FIG. 6, the device 1 for loading and unloading the grinding machine 30 is in an initial loading process. In other words, FIG. 6 shows the device 1 in a state that occurs when the device 1 loads the grinding machine 30 for the first time in a processing cycle. This can be recognized by the fact that there is no workpiece on the workpiece spindle 7 and that no workpiece is arranged between the second gripper arm 14 and the third gripper arm 15. The second gripper arm 14 and the third gripper arm 15 have assumed the release position relative to one another. The first gripper arm 13 and the second gripper arm 14 have assumed the gripping position relative to one another and have jointly gripped a first workpiece 40, which has been provided lying on a belt conveyor, for example.

Following the position shown in FIG. 6, the first workpiece 40 is transported to the workpiece spindle 7. In order to lift the first workpiece 40, the gripping device 11 can move axially along the second axis of rotation D₂ in the direction of the viewer. Irrespective of this, the first workpiece 40 is pivoted clockwise around the second axis of rotation D₂ by the first gripper arms 13 and the second gripper arm 14 until the first workpiece 40 is located above the workpiece spindle 7; in the example shown, the pivot angle is 180°. The first gripper arms 13 and the second gripper arms 14 are pivoted synchronously about the second axis of rotation D₂. Optionally, the gripping device 11 can then be moved again along the second axis of rotation D₂, in particular axially away from the viewer, in order to place the first workpiece 40 on the workpiece spindle 7. To complete the initial loading process, the first gripper arm 13 and the second gripper arm 14 are each pivoted about the second axis of rotation D₂ such that the first gripper arm 13 and the second gripper arm 14 assume a release position relative to one another and release the first workpiece 40, in particular releasing it on the workpiece spindle 7.

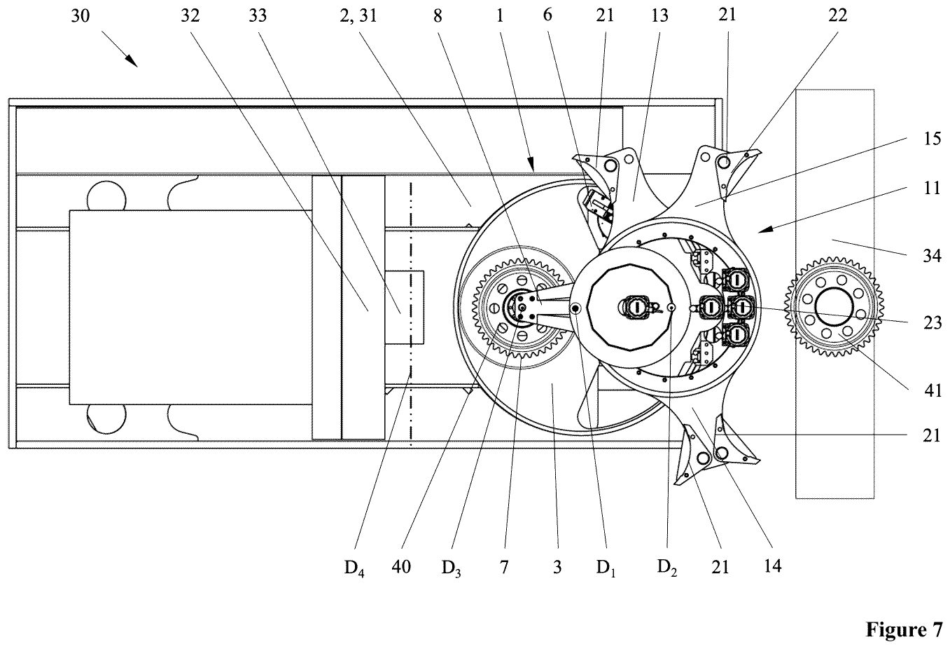

FIG. 7 shows the grinding machine 30, in particular the device 1, after completion of the initial loading process. This can be recognized by the fact that the first workpiece 40 is located on the workpiece spindle 7. In addition, the first gripper arm 13 and the second gripper arm 14 have assumed the release position relative to each other. The first gripper arm 13 and the second gripper arm 14 are spaced so far apart that the first workpiece 40 can be processed unhindered by the grinding device 32, in particular by the abrasive 33. The first gripper arm 13 and the second gripper arm 14 are pivoted relative to each other about the second axis of rotation in such a way that the distance between the first gripper arm 13 and the second gripper arm 14 is greater than the axial width of the abrasive 33. The second gripper arm 14 and the third gripper arm 15 have also assumed the release position relative to each other.

A second workpiece 41 was provided by a conveyor belt 34. As part of a workpiece change process, the second gripper arm 14 and the third gripper arm 15, starting from the position shown in FIG. 7, are pivoted about the second axis of rotation D₂ in such a way that the second gripper arm 14 and the third gripper arm 15 assume a gripping position relative to each other and grip the second workpiece 41 in the process. When the second workpiece 41 has been gripped by the second gripper arm 14 and the third gripper arm 15, the gripping device 11 can optionally be moved along the second axis of rotation D₂, in particular moved axially towards the viewer, in order to lift the second workpiece 41.

During the workpiece change process, the second workpiece 41 is pivoted clockwise around the second axis of rotation D₂ by the second gripper arm 14 and the third gripper arm 15 until it is located next to the first workpiece 40 in the circumferential direction. For this purpose, the second gripper arm 14 and the third gripper arm 15 are pivoted synchronously about the second axis of rotation D₂. Optionally, a movement of the gripping device 11 along the second axis of rotation D₂, in particular axially away from the viewer, is conceivable.

During these steps, the machining of the first workpiece 40 may continue.

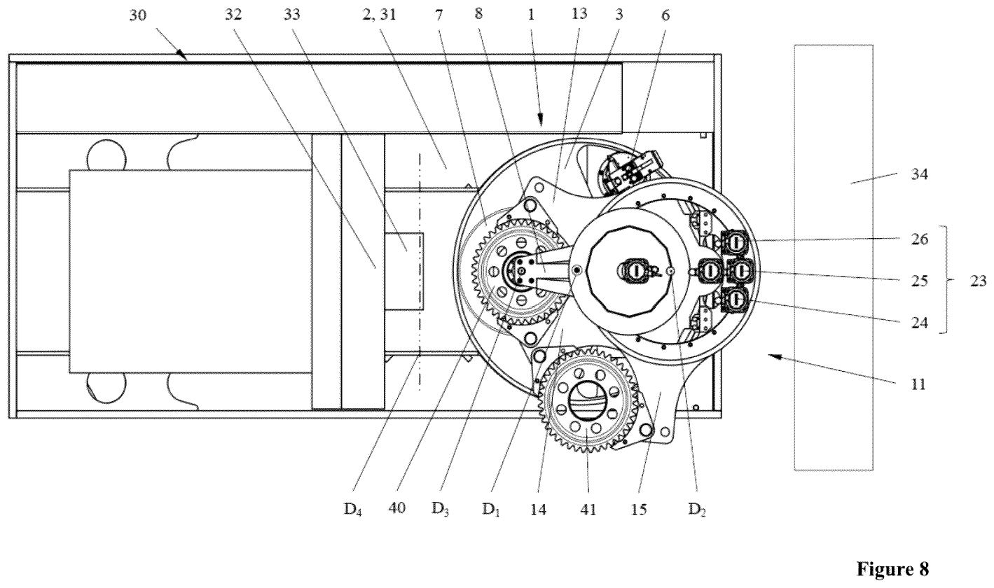

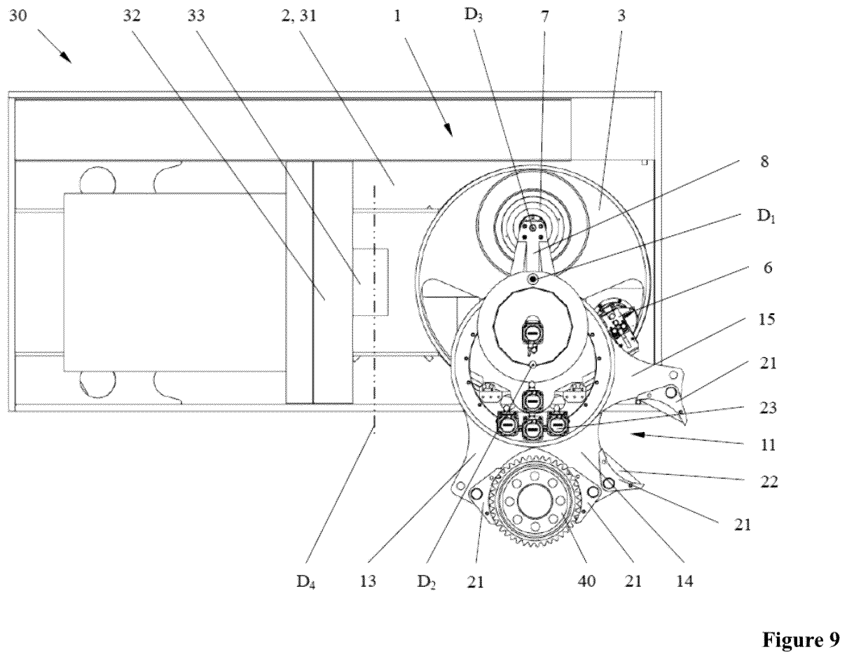

The position of the device 1, in particular of the gripping device 11, as shown in FIG. 8, is an intermediate position in the workpiece change process. In order to reach this position, the first gripper arm 13 and the second gripper arm 14 were pivoted relative to one another about the second axis of rotation D₂ after completion of the machining of the workpiece 40 in such a way that the first gripper arm 13 and the second gripper arm 14 assume a gripping position relative to one another and grip the first workpiece 40. The third gripper arm 15 is pivoted about the second axis of rotation D₂ in such a way that the third gripper arm 15 is pivoted about the second axis of rotation D₂ synchronously with the second gripper arm 14, and in particular follows the second gripper arm 14 synchronously. In other words, the second gripper arm 14 and the third gripper arm 15 remain in a gripping position independently of the movement of the second gripper arm 14. The second workpiece 41 remains between the second gripper arm 14 and the third gripper arm 15.

As part of the workpiece change process, the position shown in FIG. 8 is preferably followed by a transport operation. During the transport operation, in particular the first workpiece 40 is transported away from the workpiece spindle 7 and the second workpiece 41 is transported towards the workpiece spindle 7. Preferably, the first workpiece 40 remains between the first gripper arm 13 and the second gripper arm 14 during the transport operation. The same applies to the second workpiece 41 between the second gripper arm 14 and the third gripper arm 15. In other words, the first gripper arm 13 and the second gripper arm 14 remain in the gripping position relative to each other during the transport operation. The second gripper arm 14 and the third gripper arm 15 also remain in the gripping position relative to each other during the transport operation. To transport the workpieces 40, 41, the first gripper arm 13, the second gripper arm 14 and the third gripper arm 15 can be pivoted in synchronization with one another about the second axis of rotation D₂. Preferably, the first gripper arm 13, the second gripper arm 14 and the third gripper arm 15 are pivoted clockwise about the second axis of rotation D₂ in synchronization with one another. As a result, the workpieces 40, 41 are transported simultaneously, in particular pivoted clockwise around the second axis of rotation D₂ at the same time.

FIG. 9 shows the grinding machine 30, in particular the device 1 for loading and unloading the grinding machine 30, in a maintenance position. In the embodiment shown, the maintenance access of the grinding machine 30, via which a user can access the components of the grinding machine 30, is located at the lower edge of FIGS. 6-9. This access can also be used to manually load the grinding machine 30 with workpieces.

In order to move the device 1 to the maintenance position, the carrier 3 was rotated 90° clockwise about the first axis of rotation D₁ with respect to the machine housing 31 or with respect to the base 2. This has caused the gripping device 11 to be pivoted 90° clockwise around the first axis of rotation D₁. As a result, the gripping device 11 is positioned at the maintenance access point and is accessible to a user. It is also conceivable that the carrier 3 is rotated further about the first axis of rotation D₁ so that, for example, the dressing device 6 is positioned at the maintenance access point or is accessible to a user. Alternatively or additionally, the carrier 3 can be rotated about the first axis of rotation D₁ so that the workpiece spindle 7 is positioned at the maintenance access point or is accessible to a user.

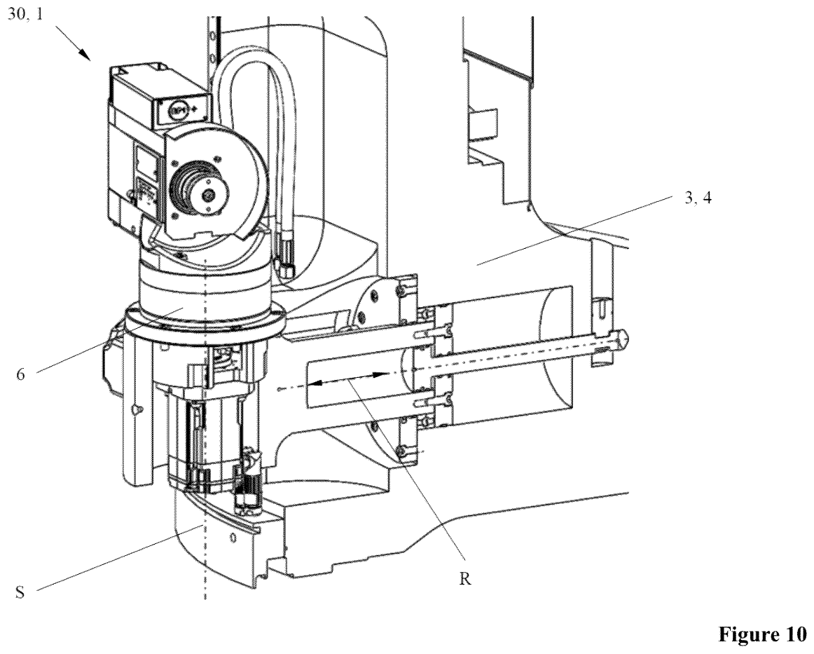

FIG. 10 shows a sectional view of a part of the grinding machine 30, namely a part of the device 1. As shown in the illustration of FIG. 10, the dressing device 6 is arranged at the lower end of the carrier tower 4 of the carrier 3. The dressing device 6 can be moved translationally in the direction of movement R shown by the arrows. This means that the dressing device 6 can be moved radially outwards and radially inwards in relation to the carrier 3 or in relation to the first axis of rotation D₁ not shown in FIG. 10. The translational movement is orthogonal to the first axis of rotation D₁.

Independently of this, the dressing device is pivotable about the pivot axis S. The pivot axis S is arranged parallel to the first axis of rotation D₁ and at a distance from the axis of rotation D₁. Due to the translational and rotational movement of the dressing device 6, the dressing device 6 can be aligned particularly precisely to the abrasive 33 in the maintenance position. As a result, the dressing of the abrasive 33 can be carried out particularly precisely.

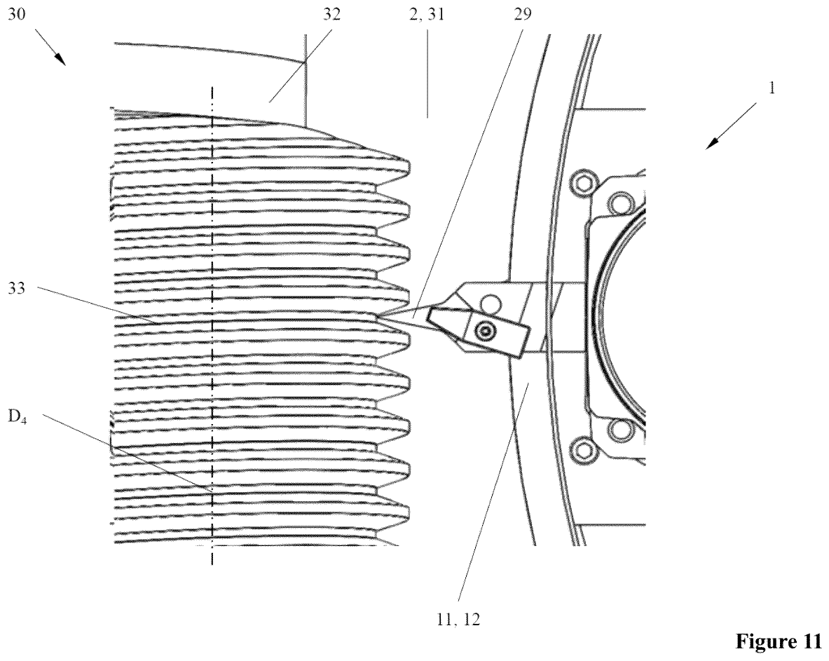

FIG. 11 shows a perspective view of a part of a further embodiment of a grinding machine 30 with a device 1 for loading and unloading the grinding machine 30. The further embodiment shown in FIG. 11 differs from the aforementioned embodiment only in that the device 1 of the further embodiment has a profiling device 29.

The profiling device 29 is attached to the base body 12 of the gripping device 11. The profiling device 29 is preferably arranged on the gripping device 11 in such a way that the profiling device 29 faces the abrasive 33 of the grinding device 32 when the device 1, in particular the carrier 3 not shown in FIG. 11, is in the maintenance position. FIG. 11 shows the device 1 in the maintenance position. In order to profile the abrasive 33, the abrasive 33 is rotated about the fourth axis of rotation D₄ and moved towards the profiling device 29. As a result, material is removed from the abrasive 33 by the profiling device 29 and the abrasive 33 is thus profiled.

1. A device for loading and unloading a machine tool for machining gears with a workpiece, the device comprising:
(a) a base,
(b) a carrier which is arranged on the base and which is rotatable about a first axis of rotation with respect to the base,
(c) a gripping device arranged on the carrier for gripping and releasing the workpiece, wherein
(d) the gripping device has at least two gripper arms which are each pivotable independently of one another about a second axis of rotation, and
(d1) the gripper arms are pivotable relative to one another about the second axis of rotation in such a way that the gripper arms can assume relative to one another a gripping position for gripping the workpiece and a release position for releasing the workpiece, and
(d2) the gripper arms are pivotable about the second axis of rotation synchronously with one another at least in the gripping position.

2. The device according to claim 1, wherein a workpiece spindle for rotating the workpiece is arranged on the carrier, the gripping device configured to load and unload the workpiece spindle with a workpiece.

3. The device according to claim 1, wherein the gripping device is axially movable along the second axis of rotation.

4. The device according to claim 1, wherein the second axis of rotation is displaced parallel with respect to the first axis of rotation.

5. The device according to claim 1, wherein the gripping device is configured to grip or release a workpiece independently of the position or rotational movement of the carrier.

6. The device according to claim 1, wherein the gripping device comprises a drive setup configured to drive the gripper arms independently of one another.

7. The device according to claim 6, wherein the drive setup comprises a plurality of drives, each drive being assigned to a respective gripper arm.

8. The device according to claim 1, wherein each gripper arm is arranged in each case on a drive ring rotatable about the second axis of rotation, the respective gripper arm being pivoted about the second axis of rotation when the corresponding drive ring rotates about the second axis of rotation.

9. The device according to claim 8, wherein the gripping device comprises a plurality of drives, each drive being assigned to a respective gripper arm, and wherein each drive ring has an internal toothing and each drive has a spur gear with an external toothing, the external toothing engaging in the internal toothing of a corresponding drive ring in order to drive the gripper arm arranged on the drive ring.

10. The device according to claim 1, wherein at least one gripper is arranged on each of the gripper arms and the grippers are configured to exert a clamping force on the workpiece in the gripping position.

11. The device according to claim 1, wherein the gripping device is configured so that several workpieces can be gripped simultaneously by the gripping device.

12. The device according to claim 1, wherein the at least two gripper arms comprise a first gripper arm, a second gripper arm and a third gripper arm, the second gripper arm being provided in the circumferential direction of the second axis of rotation between the first gripper arm and the third gripper arm.

13. The device according to claim 12, wherein the gripping device is configured in such a way that the second gripper arm
can assume a gripping position or a release position relative to the first gripper arm, and
can assume a gripping position or a release position relative to the third gripper arm.

14. The device according to claim 1, wherein the carrier is rotatable about the first axis of rotation in such a way that the carrier can be rotated back and forth between an operating position, in which the machine tool can be loaded and unloaded with the workpiece by the device, and a maintenance position, in which the machine tool and/or the device can be maintained and/or manually loaded.

15. The device according to claim 1, wherein the carrier has a vertically arranged carrier tower, the gripping device being arranged on an outer lateral surface of the carrier tower.

16. The device according to claim 1, wherein a dressing device for dressing an abrasive of the machine tool is arranged on the carrier.

17. The device according to claim 16, wherein the dressing device is movable in relation to the carrier.

18. The device according to claim 1, wherein a profiling device for pre-profiling an abrasive of the machine tool is arranged on the carrier.

19. The device according to claim 1, comprising a centering device for centering the workpiece.

20. The device according to claim 1, having a position-determining device for determining a position of the workpiece, the position determining device comprising at least one sensor.

21. A machine tool for gear grinding of a workpiece, the machine tool comprising:
a machine housing,
a grinding device arranged on the machine housing for grinding the workpiece,
a device according to claim 1 for loading the machine tool with a workpiece, wherein
the machine housing of the grinding machine is the base of the device.

22. The machine tool according to claim 21, wherein
a dressing device for dressing an abrasive of the grinding device is arranged on the carrier,
a workpiece spindle for rotating the workpiece about a third axis of rotation is arranged on the carrier, and
the carrier can be rotated about the first axis of rotation in such a way that the carrier can be rotated back and forth between a grinding position, in which the workpiece spindle faces the grinding device, and a maintenance position, in which the dressing device faces the grinding device.

23. The machine tool according to claim 21, wherein the carrier is rotatable about the first axis of rotation in such a way that the carrier assumes an access position in which a user can access the workpiece spindle.

24. A method for loading and unloading a machine tool with at least one workpiece using a device according to claim 1, wherein the at least two gripper arms comprises a first gripper arm, a second gripper arm and a third gripper arm.

25. The method according to claim 24, wherein during a workpiece change process,
the first gripper arm and the second gripper arm are pivoted relative to one another about the second axis of rotation in such a way that the first gripper arm and the second gripper arm change relative to one another from the release position into the gripping position or change from 5 the gripping position into the release position, wherein
the third gripper arm is pivoted about the second axis of rotation in such a way that the third gripper arm follows the second gripper arm synchronously.

26. The method according to claim 25, wherein the workpiece change process is a first workpiece change process and the second gripper arm is pivoted in a first pivoting direction about the second axis of rotation during the first workpiece change process, the second gripper arm being pivoted about the second axis of rotation in a second pivoting direction opposite to the first pivoting direction during a second workpiece change process.

27. The method according to claim 26, wherein during the second workpiece change process
the second gripper arm and the third gripper arm are pivoted relative to one another about the second axis of rotation in such a way that the second gripper arm and the third gripper arm change relative to one another from the release position into the gripping position or change from the gripping position into the release position, wherein
the first gripper arm is pivoted about the second axis of rotation in such a way that the first gripper arm follows the second gripper arm synchronously.

28. The method according to claim 24, wherein, during a transport operation
a first workpiece is arranged between the first gripper arm and the second gripper arm, the first gripper arm and the second gripper 5 arm assuming a gripping position relative to one another, and
a second workpiece is arranged between the second gripper arm and a third gripper arm, the second gripper arm and the third gripper arm assuming a gripping position relative to one another, and
the first gripper arm, the second gripper arm and the third gripper arm are pivoted synchronously with one another about the second axis of rotation in order to transport the first workpiece and the second workpiece.

29. The method according to claim 28, wherein the first gripper arm, the second gripper arm and the third gripper arm are pivoted synchronously with one another about the second axis of rotation in order to pivot the first workpiece and the second workpiece about the second axis of rotation.

30. The device according to claim 1, wherein the machine tool for machining gears is a hard fine machining machine.

31. The device according to claim 7, wherein the plurality of drives is a plurality of synchronous motors and wherein each synchronous motor is assigned to a respective gripper arm.

32. The device according to claim 1, wherein at least one gripper is arranged on each of the gripper arms and the grippers have a protrusion for gripping underneath the workpiece.

33. The device according to claim 17, wherein the dressing device is translationally movable, rotationally movable or translationally as well as rotationally movable in relation to the carrier.

34. The device according to claim 19, wherein the centering device is a tailstock.

35. The device according to claim 19, wherein the centering device is configured to center the workpiece on the workpiece spindle.

36. The device according to claim 20, wherein the position-determining device is configured to determine a position of at least one tooth space of the workpiece.

37. The machine tool according to claim 21, wherein the machine tool is configured for hard fine machining of a pre-toothed workpiece.
